(19) United States
(12) Patent Application Publication
(10) Pub. No.: US 2011/0172918 A1
(43) Pub. Date: Jul. 14, 2011

(54) MOTION STATE DETECTION FOR MOBILE DEVICE

(75) Inventor: Phillip Tome, Cortaillod (CH)

(73) Assignee: QUALCOMM Incorporated, San Diego, CA (US)

(21) Appl. No.: 12/686,853

(22) Filed: Jan. 13, 2010

(51) Int. Cl. G01C 21/16; G06F 15/00; G01P 15/00

(52) U.S. Cl. 701/220; 702/141

(57) ABSTRACT

Methods, apparatuses, and systems are provided to indicate whether a mobile device is at rest or in motion based, at least in part, on inertial sensor measurements obtained from one or more inertial sensors located on-board the mobile device. Inertial sensor measurements may be combined with navigation signals obtained from a satellite or terrestrial based navigation system in order to refine position, orientation, velocity, and/or acceleration estimates for the mobile device.

### BACKGROUND

1. Field

The subject matter disclosed herein relates to electronic devices, and more particularly to methods, apparatuses, and systems for use in and/or with navigation system enabled electronic devices.

2. Information

Navigation systems are a popular and increasingly important wireless technology, particularly Satellite Positioning Systems (SPS) that include, for example, the Global Positioning System (GPS) and/or other like Global Navigation Satellite Systems (GNSS). Navigation system enabled devices (e.g., mobile devices) may receive wireless navigation signals that are transmitted by transmitters affixed to one or more orbiting satellites and/or terrestrial based stations to identify a geographic position and velocity of a device. Some of these navigation system enabled devices may also include one or more inertial sensors such as accelerometers or gyroscopes. Inertial sensor measurement data obtained via these inertial sensors located on-board a device may be used in combination with the navigation signals obtained from the navigation system to refine the estimated position and velocity of the device. Hence, inertial sensor measurement data when used in combination with navigation signals obtained from a navigation system may provide a more accurate indication of position and velocity of a mobile device.

### SUMMARY

Implementations relating to detection of a state of a mobile device are disclosed. In one implementation, a method is provided that comprises obtaining a first filtered combination of two or more inertial sensor measurements of one or more inertial states of the mobile device observed within a first time frame; obtaining a second filtered combination of two or more inertial sensor measurements of one or more inertial states of the mobile device observed within a second time frame; and indicating whether the mobile device is at rest or in motion based, at least in part, on a comparison of the first filtered combination and the second filtered combination. It should be understood, however, that this summary provides merely an example implementation, and that claimed subject matter is not limited to this particular implementation.

### BRIEF DESCRIPTION OF DRAWINGS

FIG. 1 is a schematic block diagram of an example network environment according to one implementation.

FIG. 2 is a flow diagram depicting an example process for detecting a state of motion of a mobile device according to one implementation.

FIG. 3 is a flow diagram depicting another example process for detecting a state of motion of a mobile device according to one implementation.

FIG. 4 is a graph depicting an example of inertial sensor measurement data obtained from inertial sensors indicating static and dynamic states of motion of a mobile device.

### DETAILED DESCRIPTION

Inertial sensor measurements obtained on-board a mobile device may be utilized in combination with navigation system information to improve estimates of geographic position, orientation, velocity, and/or acceleration of the mobile device. Such estimates of geographic position, orientation, velocity, and/or acceleration may be provided to users of a mobile device, to third party software applications operating at the mobile device, and/or to remote computing resources where it may be used to carry out a variety of different functions. Hence, the way in which this inertial sensor measurement data is interpreted may substantially influence the quality of the resulting position, orientation, velocity, and/or acceleration estimates. Yet, a variety of factors may influence the quality of inertial sensor measurement data with respect to estimating a state of motion of a mobile device.

As one example, at least some inertial sensors may be sensitive to background noise caused by vibrations occurring at the mobile device, such as from vehicle operation (e.g., engine vibrations) and/or user movement, among other sources of noise. Under some conditions, these vibrations may mask the detection of some inertial states that are indicative of movement of the mobile device. Conversely, these vibrations may be erroneously interpreted as motion of the mobile device even if the mobile device is at rest.

Furthermore, the level of background noise contributing to errors in measurement of movement may be highly variable and may depend on a variety of factors including, for example, vehicle and/or user characteristics as well as mounting conditions of the inertial sensors themselves. Hence, the level of vibrations sensed by inertial sensors is typically not known a priori. Furthermore, variations among inertial sensors of similar or dissimilar types may exist in terms of providing different performance characteristics, sensor degradation rates, etc. These variations may make it difficult to prescribe appropriate criteria for removing background noise from inertial measurements of actual motion of a mobile device. Accordingly, the following disclosure seeks to address these and other considerations in the context of combining inertial sensor measurements with navigation system information for estimating a state of motion of a mobile device.

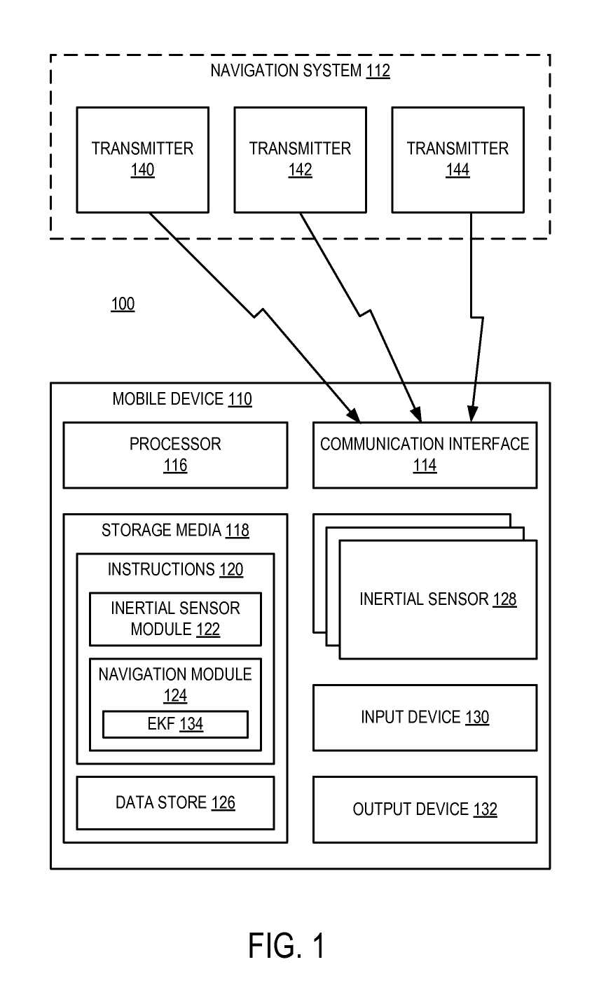

FIG. 1 is a schematic block diagram of an example network environment 100 according to one implementation. In the depicted implementation, network environment 100 includes at least a mobile device 110 and a navigation system 112. Mobile device 110 may be adapted to receive one or more navigation signals from navigation system 112, which may be used by mobile device 110 to determine or estimate state information, including position, orientation, velocity, and/or acceleration of the mobile device.

Navigation system 112 may comprise any suitable navigation system including one or more of a Satellite Positioning System (SPS) and/or a terrestrial based positioning system. Satellite positioning systems may include, for example, the Global Positioning System (GPS) and/or other like Global Navigation Satellite System (GNSS) such as Galileo or GLONASS. Terrestrial based positioning systems may include wireless cellular networks and/or WIFI networks, among other suitable wireless communication networks. At least some terrestrial based positioning systems may utilize, for example, a trilateration based approach for identifying position, orientation, velocity, and/or acceleration of a mobile device. Such trilateration may include Advanced Forward Link Trilateration (AFLT) in CDMA or Enhanced Observed Time Difference (EOTD) in GSM or Observed Time Difference of Arrival (OTDOA) in WCDMA, which measures at a mobile device the relative times of arrival of signals transmitted from each of several transmitter equipped base stations. Accordingly, navigation system 112 may include one or more transmitters 140, 142, 144, etc. to transmit one or more navigation signals that may be received by a navigation system enabled device such as mobile station 110. One or more of transmitters 140, 142, and 144 may be deployed at one or more satellites in the case of an SPS navigation system and/or one or more terrestrial based transmission stations (e.g., base stations) in the case of a terrestrial based navigation system.

Mobile device 110 may comprise any suitable navigation system enabled device, including a mobile or portable computing device or computing platform such as a cellular phone, a smart phone, a personal digital assistant, a low duty cycle communication device, a laptop computer, a personal or vehicular based navigation unit, and/or the like or combinations thereof. As other example implementations, mobile device 110 may take the form of one or more integrated circuits, circuit boards, and/or the like that may be operatively enabled for use in another device.

Mobile device 110 may include a communication interface 114 for receiving one or more navigation signals from the one or more transmitters of navigation system 112. For example, communication interface 114 may include at least a wireless receiver for receiving wireless transmissions from one or more satellite and/or terrestrial based transmitters of navigation system 112. It will be appreciated that navigation system 112 may communicate with mobile device 110 via communication interface 114 using any suitable communication protocol supported by a common network.

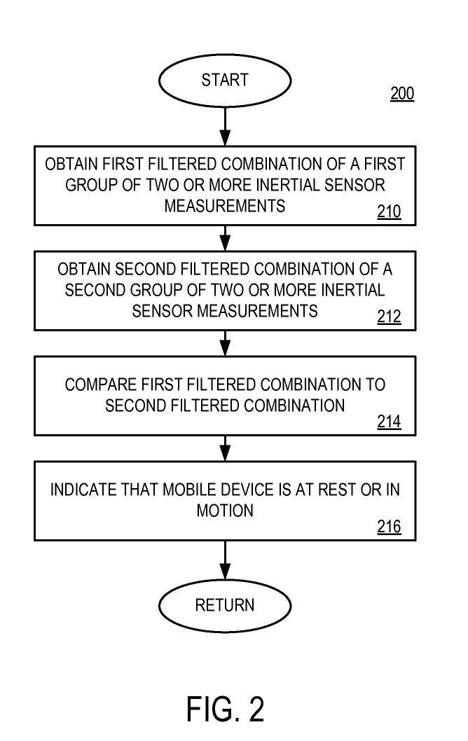

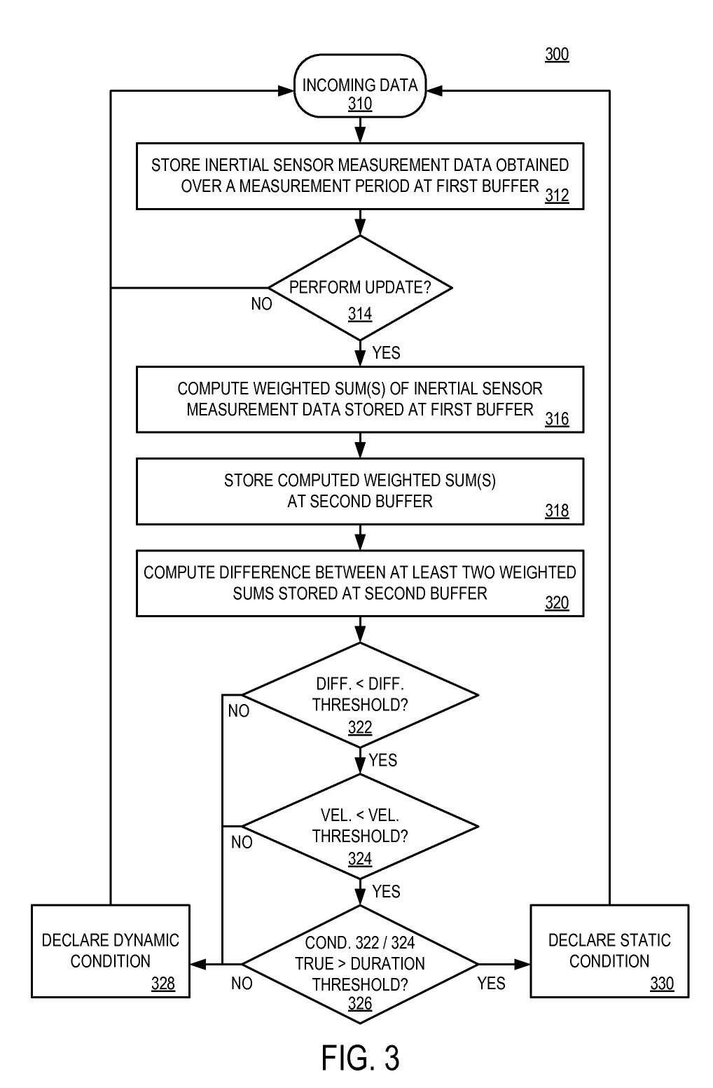

Mobile device 110 may include one or more processors such as processor 116 for executing instructions (e.g., software, firmware, executable code, etc.). Mobile device 110 may include a storage media 118 having instructions 120 stored thereon that are executable by processor 116 to perform one or more of the methods, processes, and operations disclosed herein, for example, with reference to the flow diagrams of FIGS. 2 and 3. As a non-limiting example, instructions 120 may include an inertial sensor module 122 and a navigation module 124. Storage media 118 may further include a data store 126 where inertial sensor measurement data representative of inertial sensor measurements may be stored, for example.

Mobile device 110 may include one or more inertial sensors such as inertial sensor 128, for example. An inertial sensor may include an accelerometer, a gyroscope, or other suitable device for measuring an inertial state of a mobile device. As non-limiting examples, inertial sensors may comprise accelerometers and/or gyroscopes based on Micro-Electro-Mechanical Systems (MEMS) technology, Fiber Optic Gyros (FOG), and/or Ring Laser Gyros (RLG). In some implementations, mobile device 110 may include a plurality of inertial sensors that are adapted to measure one or more inertial states of the mobile device along a plurality of different coordinate axes, thereby providing inertial measurements with respect to multiple dimensions or degrees of freedom. Inertial sensors in the form of accelerometers and/or gyroscopes are available from a variety of manufacturers including: ANALOG DEVICES, Inc.; STMICROELECTRONICS, N.V.; INVENSENSE, Inc.; KIONIX, Inc.; MURATA, Ltd.; BOSCH, Ltd.; HONEYWELL, Inc.; NORTHRUP GRUMMAN, Inc.; and IMAR, GmbH. It will be appreciated that inertial sensors may vary in quality, grade, performance, and/or durability across manufacturers and products lines.

In some implementations mobile device 110 may alternatively or additionally include other types of sensors beyond inertial sensors for which measurements may be used to estimate position, orientation, velocity, and/or acceleration. As one example, measurements obtained from one or more magnetometers and/or air pressure sensors on-board a mobile device may be used in combination with or as an alternative to inertial sensor measurements to estimate a state of the mobile device. As such, it will be appreciated that the various operations described herein with respect to the processing of inertial sensor measurements (e.g., as depicted by FIGS. 2 and 3) may also be applied to such magnetometers and/or pressure sensor measurements.

A human user may interact with mobile device 110 via one or more input devices and/or output devices. For example, mobile device 110 may include an input device 130 comprising one or more of a keyboard, a mouse, a controller, a touch-sensitive graphical display (e.g., a touch screen), a microphone, or other suitable device for receiving user input. Mobile device 110 may further include an output device 132 comprising one or more of a graphical display, an audio speaker, or other suitable device for outputting (e.g., presenting) information to a user. In some implementations, mobile device 110 may provide an indication of a geographic position, an orientation, a velocity, and/or an acceleration of the mobile device to a user via output device 132. This indication of geographic position, orientation, velocity, and/or acceleration may be updated responsive to navigation signals received from navigation system 112 and/or inertial sensor measurements obtained from on-board inertial sensors.

As a non-limiting example, in the context of network environment 100, one or more processors of mobile device 110 upon executing inertial sensor module 122 may receive one or more inertial sensor measurements from one or more inertial sensors located on-board the mobile device, and indicate whether the mobile device is at rest or in motion based, at least in part, on these inertial sensor measurements. Furthermore, one or more processors of mobile device 110 upon executing navigation module 124 may obtain one or more navigation signals received at communication interface 114 from navigation system 112, and estimate a position, an orientation, a velocity, and/or an acceleration of the mobile device based, at least in part, on the one or more navigation signals. Under at least select operating conditions, the inertial sensor module 122 may be executable by one or more processors of the mobile device to provide a motion state indicator to navigation module 124. The motion state indicator may indicate the state of motion of the mobile device and may be used by the navigation module to update and/or refine an estimated geographic position, orientation, velocity, and/or acceleration of the mobile device. As a non-limiting example, such estimates of mobile device state may be presented to a user via output device 132, provided to a third party software application hosted at processor 116, and/or transmitted to a remote computing resource via a wireless communication network where it may be used to perform a variety of different functions.

In some implementations, navigation module 124 may include an extended Kalman filter (EKF) 134. The above described motion state indicator may indicate to the navigation module that the mobile device is at rest. In turn, zero velocity and constant heading measurements may be applied to EKF 134 in order to constrain the growth of navigation errors, thereby enhancing the quality of the position, orientation, velocity, and/or acceleration estimates. In this way, the position, orientation, velocity, and/or acceleration estimates for the mobile device may be varied responsive to an indication of whether the mobile device is in a static or dynamic state of motion as indicated by the inertial sensor measurements.

FIG. 2 is a flow diagram depicting an example process 200 for detecting a state of motion of a mobile device according to one implementation. It will be appreciated that process 200 may be performed by mobile device 110 in the context of network environment 100 in at least some implementations. For example, process 200 may be performed, at least in part, by one or more processors of mobile device 110 executing the previously described inertial sensor module 122 of instructions 120.

Operation 210 may include obtaining a first filtered combination of a first group of two or more inertial sensor measurements of one or more inertial states of the mobile device observed within a first time frame. An inertial sensor measurement may refer to a measured inertial state observed by an inertial sensor. For example, such inertial sensor measurements may indicate one or more of a linear acceleration, an angular acceleration, a linear velocity, an angular velocity, a change in position, and/or a change in orientation (e.g., compass heading), among others. In the context of mobile device 110 of FIG. 1, inertial sensor measurements may be received over time from inertial sensor 128 as one or more inertial states of mobile device 110 are observed. In turn, inertial sensor module 122 may be executable by one or more processors of the mobile device to compute the first filtered combination of the inertial sensor measurements for the first time frame. In some implementations, the first filtered combination may include a first weighted sum of the first group of two or more inertial sensor measurements. As a non-limiting example, this first weighted sum may include a first average of the first group of two or more inertial sensor measurements. In some examples, an average of two or more inertial sensor measurements may be obtained by applying a low pass filter to signals that are obtained from the inertial sensor that are representative of the inertial sensor measurements. However, it will be appreciated that other suitable weighted sums may be used other than an average.

Operation 212 may include obtaining a second filtered combination of a second group of two or more inertial sensor measurements of one or more inertial states of the mobile device observed within a second time frame. In some implementations, the second filtered combination may include a second weighted sum of the second group of two or more inertial sensor measurements. As a non-limiting example, this second weighted sum may include a second average of the second group of two or more inertial sensor measurements.

Operation 214 may include comparing the first filtered combination to the second filtered combination. In some examples, the comparison performed at operation 214 may include determining a difference between the first filtered combination and the second filtered combination obtained at operations 210 and 212, respectively. In other examples, the comparison performed at operation 214 may include identifying a rate of change (e.g., as a derivative) of two or more filtered combinations. In the context of mobile device 110 of FIG. 1, inertial sensor module 122 may be executable by one or more processors to compare the first filtered combination to the second filtered combination to identify a difference or a rate of change between the first and second filtered combinations. In this way, inertial sensor measurements obtained from a first time frame may be compared to inertial sensor measurements obtained from a subsequently occurring second time frame.

For example, if the size of the first and second time frames are equal to a motion state update interval (e.g. 1/10 Hz=100 ms), then the first and second time frames may be consecutive in time to each other. However, if the size of the first and second time frames are larger than the update interval (e.g. 200 ms), then the first and second time frames may be overlapping in time. Hence, in some implementations, this first time frame may be at least partially overlapping in time with the second time frame, and may therefore share at least some of the same inertial sensor measurements. In other implementations, the second time frame may follow immediately in time (e.g., consecutive in time to) the first time frame, where the last inertial sensor measurement of the first time frame may be obtained immediately prior to the first inertial sensor measurement of the second time frame. In yet other implementations, the second time frame may be spaced apart in time from the first time frame, where one or more inertial sensor measurements may be received or obtained between the last inertial sensor measurement of the first time frame and the first inertial sensor measurement of the second time frame.

Operation 216 may include indicating whether the mobile device is at rest or in motion based, at least in part, on the comparison of the first filtered combination and the second filtered combination of the inertial sensor measurements. In at least some implementations, operation 216 may include indicating that the mobile device is at rest (e.g., has substantially zero velocity) if a magnitude of a difference between the first filtered combination and the second filtered combination is less than a difference threshold as identified by the comparison performed at operation 214. For example, the mobile device may be indicated to be in motion in response to the comparison indicating an increased difference between the first filtered combination and the second filtered combination, whereas the mobile device may be indicated to be at rest in response to the comparison indicating a smaller difference between the first filtered combination and the second filtered combination.

It will be appreciated that some implementations may utilize a hysteresis band for distinguishing between a state of rest and a state of motion of the mobile device, whereby a plurality of difference thresholds may be used depending on the mobile device's current or initial state of motion. For example, a lower difference threshold (or conversely a higher difference threshold) may be compared to the difference between the first and second filtered combinations for determining whether a change from a state of motion to a state of rest has occurred. By contrast, a higher difference threshold (or conversely a lower difference threshold) may be compared to the difference between the first and second filtered combinations for determining whether a change from a state of rest to a state of motion has occurred. Of course these are merely examples of how different thresholds may be applied given a current state, and claimed subject matter is not limited in this respect.

By comparing filtered combinations of inertial sensor measurements obtained from different time frames, the impact of variations in sensor accuracy, precision, degradation, and/or quality may be reduced with respect to identification of a state of motion of a mobile device. Furthermore, the impact of variations in background noise, including vibration characteristics of the environment to which the mobile device is deployed may also be reduced by comparing these filtered combinations.

In some implementations, indicating that the mobile device is at rest may comprise maintaining an estimated position and/or orientation of the mobile device, whereas indicating that the mobile device is in motion may comprise updating an estimated position, orientation, velocity, and/or acceleration of the mobile device. For example, as previously described in the context of mobile device 110, inertial sensor module 122 may communicate a motion state indicator to navigation module 124 to indicate whether the mobile device is in motion or at rest. In turn, the motion state indicator may influence the estimated position, orientation, velocity, and/or acceleration of the mobile device as computed by the navigation module. Such estimates of the mobile device state may be utilized onboard the mobile device or may be transmitted to a remote computing resource. For example, a user of the mobile device may be presented with an indication of the mobile device state via an output device such as a graphical display.

Additionally, in some implementations, indicating that the mobile device is at rest may comprise biasing one or more inertial sensors at the mobile device to reflect a rest state of the mobile device, thereby reducing drift in one or more of the inertial sensors that may otherwise occur through use and/or degradation of the inertial sensors. Such biasing of inertial sensors may be improved in at least some scenarios based on the above described comparison of filtered combinations of inertial sensor measurements which is less influenced by sensor drift.

From operation 216, the process flow may return to operation 210 to obtain additional filtered combinations of inertial sensor measurements of subsequently observed inertial states of the mobile device. In some implementations, process 200 may be separately performed for individual inertial sensors or groups of inertial sensors of the mobile device, whereby the first filtered combination and the second filtered combination may be obtained from the same inertial sensor or group of inertial sensors.

FIG. 3 is a flow diagram depicting another example process 300 for detecting a state of motion of a mobile device according to one implementation. In at least some examples, process 300 provides a more specific implementation of previously described process 200 of FIG. 2. It will also be appreciated that process 300 may be performed by mobile device 110 of FIG. 1 in at least some implementations. For example, process 300 may be performed, at least in part, by one or more processors of mobile device 110 executing instructions 120 including inertial sensor module 122. Although process 300 will be described with respect to a single inertial sensor for the purpose of clarity, it will be appreciated that process 300 may be performed using inertial sensor measurement data obtained from a plurality of inertial sensors.

At operation 310, incoming data in the form of inertial sensor measurements may be received from an inertial sensor located on-board a mobile device. As previously described, these inertial sensor measurements may indicate one or more inertial states of the mobile device. Operation 312 may include storing at a first buffer, the inertial sensor measurement data obtained over a prescribed measurement period. As a non-limiting example, this first buffer may comprise part of data store 126 of FIG. 1. The measurement period for which inertial sensor measurement data is obtained may be of any suitable length of time and may be defined so that at least two or more inertial sensor measurements may be obtained within the measurement period. As such, the measurement period may be based on a sampling rate of the inertial sensor to ensure that at least two inertial sensor measurements are obtained for a measurement period. As a non-limiting example, such a measurement period may be defined to be a fraction of a second (e.g., 10 Hz) or one or more seconds in duration, although any suitable duration of time may be used. In the context of process 200 of FIG. 2, the first and second time frames from which inertial states of the mobile device are observed by the inertial sensors may each be of a duration that is defined by this measurement period.

At operation 314, if an update to an estimated state of the mobile device is to be performed (e.g., according to a motion state update interval), then the process flow may proceed to operation 316. Otherwise, the process flow may return to operation 310 where inertial sensor measurement data may be subsequently received and again stored in accordance with operation 312. It will be appreciated that this update to the estimated state of the mobile device may correspond to the previously described motion state indicator that may be provided to the navigation module by the inertial sensor module.

As a result of operation 314, inertial sensor measurement data of a plurality of measurement periods may be stored at the first buffer before it is determined that an update is to be performed at 314. In some implementations, the first buffer may be adapted to store inertial sensor measurement data for only a fixed number of measurement periods. For example, the first buffer may comprise a circular buffer that is adapted to hold inertial sensor data for two, three, four, five, or more (or other suitable number) of the most recently acquired measurement periods. As such, older inertial sensor measurement data stored at the first buffer may be periodically overwritten with newer inertial sensor measurement data in some implementations.

If an update to an estimated state of motion of the mobile device is to be performed, then operation 316 may be performed to compute one or more weighted sums of the inertial sensor measurement data stored at the first buffer. As previously described, a weighted sum of the inertial sensor measurements may include an average of two or more inertial sensor measurements. Where the first buffer includes inertial sensor measurement data of a plurality of measurement periods, a weighted sum may be computed for some or all of the measurements in the first buffer. For example, if the first buffer includes two measurement periods of inertial sensor measurement data, then operation 316 may comprise computing two weighted sums for the inertial sensor measurement data of each of the two respective measurement periods. In some implementations, where the first buffer includes inertial sensor measurement data of three or more measurement periods, operation 316 may comprise computing only two weighted sums of the inertial sensor measurement data for the most recent entry and oldest entry in the first buffer.

Operation 318 may include storing the one or more weighted sums computed at operation 316 at a second buffer. This second buffer may also comprise part of data store 126 of FIG. 1. In some implementations, the second buffer may be adapted to store only a prescribed number of weighted sums. As a non-limiting example, the second buffer may comprise a circular buffer that is adapted to hold the two, three, four, five or more (or any suitable number) of the most recently computed weighted sums.

Operation 320 may include computing a difference between at least two weighted sums stored at the second buffer. In some implementations, operation 320 may comprise computing a difference between the weighted sum of the most recently obtained inertial sensor measurement data and the weighted sum of the oldest inertial sensor measurement data of the second buffer.

At operation 322, in response to the difference computed between the two weighted sums at operation 320 being greater than a difference threshold, the process flow may proceed to operation 328 where a dynamic condition of the mobile device is declared. Alternatively, in response to the difference between the two weighted sums being less than the difference threshold, the process flow may optionally proceed to operations 324 and/or 326 where additional checking or verification may be performed to determine whether a static condition of the mobile device is to be declared. However, in some implementations, one or more of operations 324 and 326 may be omitted.

At operation 324, a check may be performed to confirm that a state of motion of the mobile device as indicated by the inertial sensor measurements is in agreement with a state of motion of the mobile device as indicated by a navigation system. In some implementations, the mobile device may be indicated to be in motion (e.g., a dynamic state) in response to the indication of velocity of the mobile device obtained from the navigation system indicating a higher velocity. By contrast, the mobile device may be indicated to be at rest (e.g., a static state) in response to the indication of velocity of the mobile device indicating a lower velocity. For example, a velocity of the mobile device as indicated by a state of a Kalman filter maintained by the navigation system may be compared to a velocity threshold at 324. If a velocity of the mobile device as indicated by the Kalman filter state is not less than the velocity threshold, then the process flow may proceed to operation 328 where a dynamic condition of the mobile device may be declared. Alternatively, if the velocity of the mobile device as indicated by the Kalman filter state is less than the velocity threshold, then the process flow may proceed to operation 326, or may proceed to operation 330 if operation 326 has been omitted.

At operation 326, a check may be performed as to whether the conditions identified at operations 322 and 324 are satisfied for at least a threshold period of time (e.g., 2.0 seconds or other suitable duration). For example, in response to the velocity condition identified at operation 324 being true for less than the duration threshold or the difference condition identified at operation 322 being true for less than the duration threshold, the process flow may proceed to operation 328 where the dynamic condition of the mobile device may be declared. Alternatively, in response to the velocity condition identified at operation 324 being true for at least the duration threshold and the difference condition identified at operation 322 being true for at least the threshold duration, the process flow may instead proceed to operation 330 where a static condition of the mobile device may be declared.

If a dynamic condition of the mobile device is declared at operation 328, then the mobile device has been identified as being in a state of motion. Accordingly, a motion state indicator that indicates that the mobile device is in motion may be provided to the navigation module (e.g., where it may be applied by EKF 134). If a static condition of the mobile device is instead declared at operation 330, then the mobile device has instead been identified as being in a state of rest. Accordingly, a motion state indicator that indicates that the mobile device is at rest may be provided to the navigation module.

From operations 328 or 330, the process flow may return to operation 310 where process 300 may be again performed for subsequently obtained inertial sensor measurement data. In this way, detection of changes between a state of motion and a state of rest of the mobile device may be identified in response to changes in the filtered combinations of inertial sensor measurement data received from one or more inertial sensors. As previously described in process 200, process 300 may also be separately performed in some implementations for each individual inertial sensor. In other implementations, process 300 may be performed for inertial sensor measurement data obtained from groups of two or more inertial sensors.

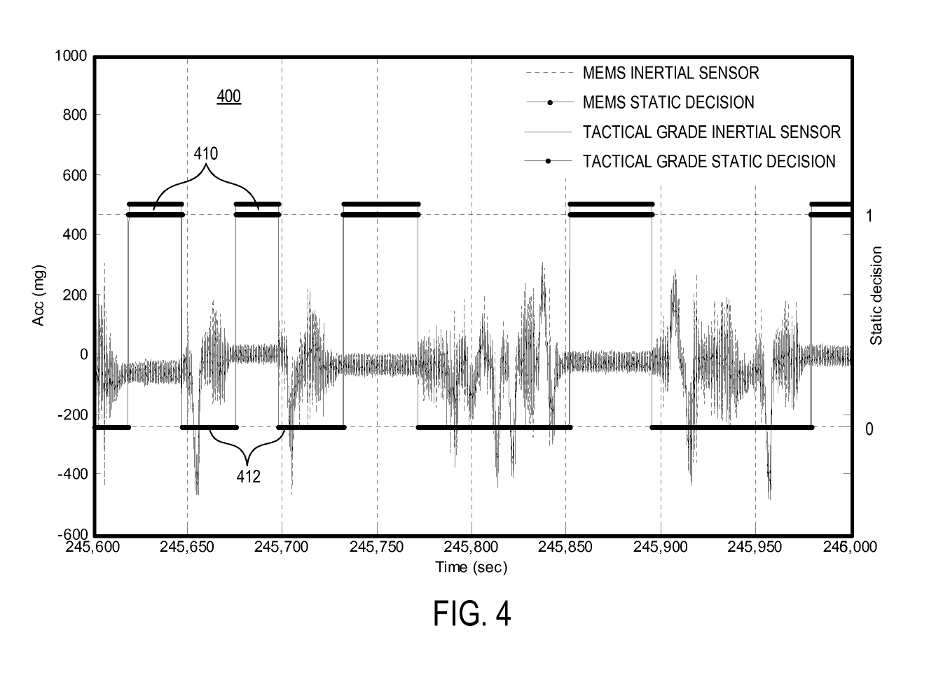

FIG. 4 is a graph 400 depicting an example of inertial sensor measurement data obtained from inertial sensors indicating static and dynamic states of motion of a mobile device. In graph 400, inertial sensor measurements obtained from inertial sensors having different grades or performance characteristics were acquired simultaneously during a vehicle test. For example, inertial sensor measurements was obtained from a MEMS inertial sensor and a tactical grade inertial sensor (e.g., such as a FOG inertial sensor).

Graph 400 further depicts static detection periods at 410 and dynamic detection periods at 412 using one or more of previously described processes 200 and 300 of FIGS. 2 and 3. For the inertial sensor measurement data obtained from each inertial sensor, level 0 indicated on the right vertical axis represents a dynamic state of motion of the mobile device and level 1 depicted on the right vertical axis represents a static state of motion of the mobile device. In graph 400, the level of detection obtained from the inertial sensor measurement data of the tactical grade inertial sensor is shifted away from the level 1 so that it may be distinguished from the level of detection obtained from the inertial sensor measurement data of the MEMS inertial sensor. As may be observed from graph 400, the applied process for detecting static and dynamic states of motion of a mobile device provide similar indications of static and dynamic events for different inertial sensor grades.

The mobile devices described herein may be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described storage media may comprise primary, secondary, and/or tertiary storage media. Primary storage media may include memory such as random access memory and/or read-only memory, for example. Secondary storage media may include mass storage such as a magnetic or solid state hard drive. Tertiary storage media may include removable storage media such as a magnetic or optical disk, a magnetic tape, a solid state storage device, etc. In certain implementations, the storage media or portions thereof may be operatively receptive of, or otherwise configurable to couple to, other components of a computing platform, such as a processor. In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the above description, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features. In the preceding detailed description, numerous specific details have been set forth to provide a thorough understanding of claimed subject matter.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

1. A method, comprising:
obtaining a first filtered combination of two or more inertial sensor measurements of one or more inertial states of a mobile device observed within a first time frame;
obtaining a second filtered combination of two or more inertial sensor measurements of one or more inertial states of the mobile device observed within a second time frame; and
indicating whether the mobile device is at rest or in motion based, at least in part, on a comparison of the first filtered combination and the second filtered combination.

2. The method of claim 1, wherein said indicating comprises:
indicating that the mobile device is in motion in response to the comparison indicating an increased difference between the first filtered combination and the second filtered combination; and
indicating that the mobile device is at rest in response to the comparison indicates a smaller difference between the first filtered combination and the second filtered combination.

3. The method of claim 1, wherein the first filtered combination includes a first weighted sum of the two or more inertial sensor measurements observed within the first time frame; and
wherein the second filtered combination includes a second weighted sum of the two or more inertial sensor measurements observed within the second time frame.

4. The method of claim 3, wherein the first weighted sum includes a first average of the two or more inertial sensor measurements observed within the first time frame; and
wherein the second weighted sum includes a second average of the two or more inertial sensor measurements observed within the second time frame.

5. The method of claim 1, wherein indicating that the mobile device is at rest comprises maintaining an estimated position of the mobile device; and
wherein indicating that the mobile device is in motion comprises updating one or more of an estimated position and/or an estimated velocity of the mobile device.

6. The method of claim 1, wherein indicating that the mobile device is at rest comprises biasing one or more inertial sensors at the mobile device to reflect a rest state of the mobile device.

7. The method of claim 1, further comprising:
obtaining an indication of velocity of the mobile device via a navigation system; and
wherein said indicating whether the mobile device is at rest or in motion further comprises:
indicating that the mobile device is in motion in response to the indication of velocity of the mobile device indicating a higher velocity; and
indicating that the mobile device is at rest in response to the velocity of the mobile device indicating a lower velocity.

8. The method of claim 7, wherein indicating that the mobile device is at rest further comprises:
indicating that the mobile device is at rest in response to the lower velocity indicated by the navigation system being maintained for at least a threshold period of time.

9. The method of claim 8, wherein indicating that the mobile device is at rest further comprises:
indicating that the mobile device is at rest in response to the comparison of the first filtered combination and the second filtered combination exhibiting a difference that is less than a difference threshold for at least the threshold period of time.

10. The method of claim 1, wherein said indicating whether the mobile device is at rest or in motion further comprises:
providing a motion state indicator to a navigation module, said motion state indicator indicating whether the mobile device is at rest or in motion; and
wherein said motion state indicator enables the navigation module to vary an estimated position and/or an estimated velocity of the mobile device based upon said motion state indicator.

11. The method of claim 1, wherein the second time frame is at least partially overlapping in time with the first time frame.

12. The method of claim 1, wherein the second time frame follows immediately in time from the first time frame.

13. The method of claim 1, wherein the second time frame is spaced apart in time from the first time frame.

14. An apparatus, comprising:
a mobile device, comprising:
one or more inertial sensors to measure one or more inertial states of the mobile device;
a processor programmed with instructions to:
obtain a first filtered combination of two or more inertial sensor measurements observed by the one or more inertial sensors within a first time frame;
obtain a second filtered combination of two or more inertial sensor measurements observed by the one or more inertial sensors within a second time frame; and
indicate whether the mobile device is at rest or in motion based, at least in part, on a comparison of the first filtered combination and the second filtered combination.

15. The apparatus of claim 14, wherein the processor is further programmed with instructions to:
indicate that the mobile device is in motion in response to the comparison indicating an increased difference between the first filtered combination and the second filtered combination; and
indicate that the mobile device is at rest in response to the comparison indicating a smaller difference between the first filtered combination and the second filtered combination.

16. The apparatus of claim 14, wherein the first filtered combination includes a first weighted sum of the two or more inertial sensor measurements observed within the first time frame; and
wherein the second filtered combination includes a second weighted sum of the two or more inertial sensor measurements observed within the second time frame.

17. The apparatus of claim 14, further comprising an extended Kalman filter;
wherein the processor is further programmed with instructions to:
provide a motion state indicator to the extended Kalman filter, said motion state indicator indicating whether the mobile device is at rest or in motion; and
wherein said motion state indicator enables the extended Kalman filter, in combination with one or more navigation signals received from a navigation system, to vary an estimated position and/or an estimated velocity of the mobile device based, at least in part, on said motion state indicator.

18. The apparatus of claim 14, further comprising a communication interface to receive one or more navigation signals from a navigation system; and
wherein the processor is further programmed with instructions to:
obtain an indication of velocity of the mobile device from the navigation system via the communication interface; and
indicate that the mobile device is in motion in response to the velocity of the mobile device obtained from the navigation system indicating a higher velocity; and
indicate that the mobile device is at rest in response to the velocity of the mobile device obtained from the navigation system indicating a lower velocity.

19. An apparatus, comprising:
means for obtaining a first filtered combination of two or more inertial sensor measurements of one or more inertial states of a mobile device observed within a first time frame;
means for obtaining a second filtered combination of two or more inertial sensor measurements of one or more inertial states of the mobile device observed within a second time frame;
means for comparing the first filtered combination and second filtered combination to obtain a result; and
means for indicating whether the mobile device is at rest or in motion based, at least in part, on the result of the comparison of the first filtered combination and the second filtered combination.

20. The apparatus of claim 19, further comprising:
means for indicating that the mobile device is in motion in response to the result of the comparison indicating an increased difference between the first filtered combination and the second filtered combination; and
means for indicating that the mobile device is at rest in response to the result of the comparison indicating a smaller difference between the first filtered combination and the second filtered combination.

21. The apparatus of claim 19, wherein said means for indicating whether the mobile device is at rest or in motion further includes a means for providing a motion state indicator to a navigation module, wherein said motion state indicator enables the navigation module to update one or more of an estimated position and/or an estimated velocity of the mobile device based on said motion state indicator.

22. An article, comprising:
a storage medium having stored thereon instructions executable by a processor to:
obtain a first filtered combination of two or more inertial sensor measurements of one or more inertial states of a mobile device observed within a first time frame;
obtain a second filtered combination of two or more inertial sensor measurements of one or more inertial states of the mobile device observed within a second time frame;
indicate whether the mobile device is at rest or in motion based, at least in part, on a comparison of the first filtered combination and the second filtered combination.

23. The article of claim 22, wherein the instructions are further executable by the processor to:
indicate that the mobile device is in motion in response to a result of the comparison indicating an increased difference between the first filtered combination and the second filtered combination; and
indicate that the mobile device is at rest in response to the result of the comparison indicating a lesser difference between the first filtered combination and the second filtered combination.

24. The apparatus of claim 22, wherein the instructions are further executable by the processor to further indicate whether the mobile device is at rest or in motion by:
obtaining an indication of velocity of the mobile device from a navigation system; and
indicating that the mobile device is in motion in response to the velocity of the mobile device obtained from the navigation system indicating a higher velocity; and
indicating that the mobile device is at rest in response to the velocity of the mobile device obtained from the navigation system indicating a lower velocity.
